(19) United States
(12) Patent Application Publication
(10) Pub. No.: US 2011/0061471 A1
(43) Pub. Date: Mar. 17, 2011

(54) System and method of verification of a sample for a flow cytometer

(76) Inventors: Collin A. Rich, Ypsilanti, MI (US); Jack T. Ball, Ann Arbor, MI (US); Grant C. Howes, Ann Arbor, MI (US)

(21) Appl. No.: 12/942,846

(22) Filed: Nov. 9, 2010

Related U.S. Application Data
(63) Continuation-in-part of application No. 12/792,536, filed on Jun. 2, 2010.
(60) Provisional application No. 61/183,328, filed on Jun. 2, 2009.

(51) Int. Cl. G01N 1/20

(52) U.S. Cl. 73/863.02

(57) ABSTRACT

A system and method for a flow cytometer system including a sheath pump that pumps sheath fluid from a sheath container into an interrogation zone, a waste pump that pumps waste fluid from the interrogation zone into a waste container, wherein the sheath pump and waste pump cooperatively and simultaneously draw sample fluid from a sample container into the interrogation zone, a controller that adjusts the flow rate of the sample fluid from the sample container into the interrogation zone, and a sensor system that coordinates with the controller to measure the amount of sample fluid in the sample container when the controller substantially pauses the sample fluid flow from the sample container into the interrogation zone. The system may further include a processor that monitors a measured volume of sample fluid introduced into the flow cytometer and an expected sample volume.

### CROSS-REFERENCE TO RELATED APPLICATIONS

This application is a continuation-in-part of U.S. patent application Ser. No. 12/792,536 filed 2 Jun. 2010, which claims the benefit of U.S. Provisional Application No. 61/183,328, filed on 2 Jun. 2009. Both applications are incorporated in their entirety by this reference.

### TECHNICAL FIELD

This invention relates generally to the flow cytometer field, and more specifically to a new and useful system and method for verification of a sample in the flow cytometer field.

### BACKGROUND

The results from a flow cytometer analysis of microscopic particles often depend on a sample fluid prepared by a machine and/or an experimenter. Errors in the preparation of the sample fluid may drastically alter the accuracy and conclusion of the flow cytometer analysis. As a real world example, CD₄ tests are used in determining the state of the immune system of a patient and the progression of HIV to AIDS. A CD₄ count of 200 or lower is used to indicate that a patient with HW has AIDS. During this determination, reference beads are added to a blood sample, and counted by a flow cytometer to calculate the volume of blood analyzed by the flow cytometer. The calculated volume of blood and the number of CD₄ particles analyzed during the flow cytometer test are used to calculate the CD₄ count. An improperly prepared blood sample, such as one where the concentration of reference beads is not as expected, can lead to false positives and a misdiagnosis. Thus, there is a need in the flow cytometer field to create a new and useful system and method for verification of a sample. This invention provides such a new and useful system and method.

### BRIEF DESCRIPTION OF THE FIGURES

FIG. 1 is a schematic representation of a system of the preferred embodiment of the invention;

FIG. 2 is schematic representation of a system of the preferred embodiment of the invention;

FIG. 3 is a flowchart of a method of a preferred embodiment of the invention;

FIG. 4 is a schematic representation of a system of the preferred embodiment of the invention;

FIG. 5 is schematic representation of a system of the preferred embodiment of the invention;

FIGS. 6A-6C are schematic representations of variations of direct volume sensing fluidic systems;

FIGS. 7A-7C are schematic representations of variations of indirect volume sensing fluidic systems;

FIG. 8 is a schematic representation of preparing a sample fluid with a plurality of reference bead types; and

FIGS. 9A ad 9B are schematic representations of a method of an alternative embodiment of the invention.

### DESCRIPTION OF THE PREFERRED EMBODIMENTS

The following description of the preferred embodiments of the invention is not intended to limit the invention to these preferred embodiments, but rather to enable any person skilled in the art of flow cytometers to make and use this invention.

### 1. Flow Cytometer System for the Verification of a Prepared Sample

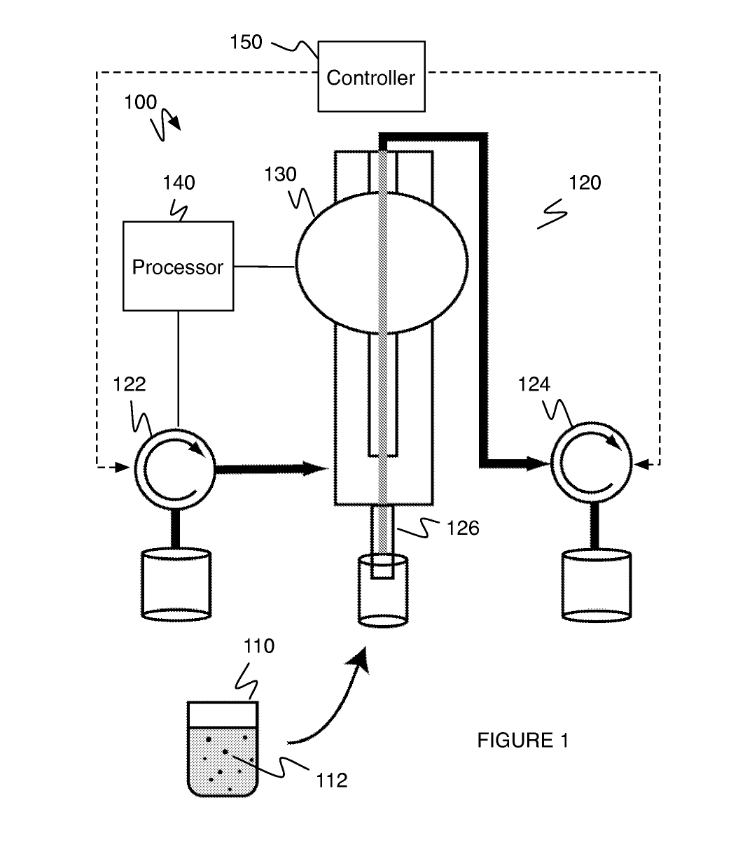

As shown in FIG. 1, the flow cytometer system 100 of the preferred embodiment for the verification of a prepared sample includes a sample fluid prepared with beads 110, a peristaltic fluid system 120, an interrogation zone 130, and a processor 140. The peristaltic pump system 120 preferably includes a sheath pump 122, a waste pump 124, and a sample injection probe (SIP) 126. The flow cytometer system 100 functions to compare the actual sample volume as determined by the peristaltic pump system 120 to the expected volume of the prepared sample 110 (as preferably indicated by the reference beads in the sample). Discrepancies in these two volume measurements is preferably handled by flagging data, alerting the experimenter, correcting for volume discrepancies, modification of a sample, and/or any suitable response. The peristaltic pump system 120 of the preferred embodiment preferably enables the flow cytometer system 100 to monitor the actual volume of sample fluid 110 passing through the interrogation zone 130 with a high level of accuracy due to the unique use of peristaltic pumps. As an exemplary use of the flow cytometer system 100, the prepared sample fluid 110 is preferably prepared with a reagent(s) for a CD₄ test. The prepared sample fluid 110 preferably has an expected reference bead concentration. The reference beads of the reagent(s) are preferably counted in the interrogation zone 130, and an expected sample volume based on the reference bead count is preferably calculated. The expected volume based on this data collection is then preferably compared to the volume sampled according to the operation of the peristaltic fluid system 120.

The sample fluid prepared with beads no of the preferred embodiment functions to be the fluid with countable microscopic particles for the flow cytometer analysis. The sample fluid 110 preferably includes a sample of blood, but the sample fluid 110 may alternatively be any suitable fluid to be analyzed by the flow cytometer interrogation zone 130. The sample fluid 110 is preferably prepared with an expected concentration and/or volume of diluents (reagents, markers, and/or any suitable fluids). Reference beads 112 are preferably added to the sample fluid no. The reference beads 112 function to be countable markers or reference particles that are preferably counted by the flow cytometer as the sample fluid passes through the interrogation zone 130. An ideally prepared sample fluid 110 will preferably have a known reference bead count per sample volume. The reference beads 112 may alternatively not be an additive but be a particle with a known concentration in the blood or fluid sample. In one variation, the beads are factory mixed with a test reagent(s) (which includes any necessary reagents) that is used during the preparation of the sample. The reference beads concentration is preferably a well-controlled value for the test reagent(s). The test reagent(s) is then added to the sample fluid during the preparation of the sample. In another variation, the reference beads 112 may alternatively be added or packaged for a set volume of a container (e.g., a test tube). When added to a known volume of fluid the concentration of reference beads will be known. Alternatively, the reference beads 112 may be added separately to the diluent, sample, and/or be added in any suitable means.

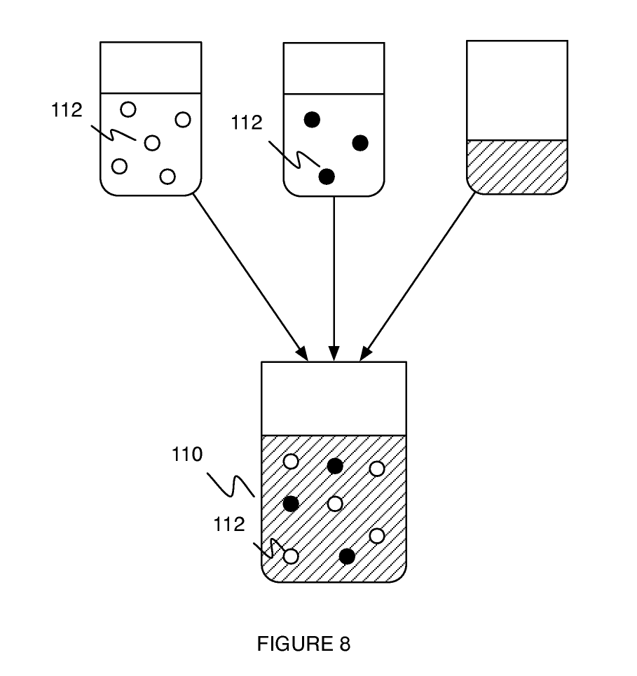

As an additional variation, the sample fluid may be prepared with a plurality of differing types of reference beads 112. The plurality of types of reference beads 112 preferably functions to create an ratio of reference beads that can be measured by the flow cytometer and compared to an expected reference bead ratio. Additionally, any suitable number of types of regents may alternatively be used. A first type of reference beads 112 can preferably be distinguished from an at least second type of reference beads 112. The plurality of types of reference beads preferably has differing size or fluorescence so that the flow cytometer can distinguish between the two reference beads though any suitable difference may alternatively be used. The flow cytometer can preferably count the number of first reference beads 112 and at least second type of reference beads 112. The first type of reference bead 112 is preferably prepared at a known concentration in a first portion of the sample fluid (e.g., a first reagent), and the at least second type of reference bead is preferably prepared at a known concentration in a second portion of the sample fluid (e.g., a second reagent). The two portions of the sample fluid are preferably combined to form the sample fluid. The ratio of the first type of reference beads to the at least second type of reference beads preferably has an expected value. The flow cytometer can preferably determine the ratio of reference beads in the sample fluid by counting the reference beads. If the expected ratio of reference beads does not substantially match the measured ratio then the sample may have been prepared wrong and any suitable action may be taken. As an example shown in FIG. 8, a liquid antibody reagent containing a known concentration of reference beads A may be added to a blood sample. A lysis reagent containing a concentration of reference beads B is then preferably added to the sample fluid. The quantities of the regents added to the sample fluid can then preferably be verified by measuring the ratio of reference beads A to reference beads B. The ratio preferably has an expected value. If the measured ratio of plurality of reagents is the expected value, and if the correct volume of both the antibody and lysis reagents have been added and the concentration of reference beads is correct then the right amount of blood has been added to the sample fluid.

The peristaltic pump system 120 of the preferred embodiment functions to control the flow of the sample fluid. The peristaltic pump system 120 is preferably the same system shown and disclosed in U.S. patent application Ser. No. 11/370,714 (filed on 8 Mar. 2006 and published on 13 Sep. 2007 as U.S. Pub. No. 2007/0212262), which is hereby incorporated in its entirety. The peristaltic pump system 120 may, however, be any suitable system that functions to control the flow of the sample fluid. The peristaltic pump system preferably has accurate knowledge of the volume of sample fluid that has been passed through the inspection zone. The volume of sample fluid 110 that has passed through the inspection zone is preferably related to the operation of the peristaltic pump system 120. Thus preferably through control and operation of the peristaltic pump system 120, the volume of sample fluid 110 passed through the interrogation zone should be known value. The peristaltic pump system 120 preferably includes a sheath pump 122, a waste pump 124, and a sample injection probe (SIP) 126.

The sheath pump 122 of the preferred embodiment functions to pump sheath fluid from a sheath container into the interrogation zone 130. The sheath fluid functions to hydrodynamically focus the sample fluid. The process of hydrodynamic focusing results in laminar flow of the sample fluid within a flow cell of the interrogation zone of the flow cytometer and enables an optical system to illuminate, and thus analyze, the particles within the sample fluid with uniformity and repeatability. Preferably, the sheath fluid is buffered saline or de-ionized water, but the sheath fluid may alternatively be any suitable fluid to hydrodynamically focus the sample fluid. A sheath container functions to contain the sheath fluid before being pumped. The sheath container is preferably a vented tank with a volume of approximately 1 L, but the sheath tank may alternatively be any suitable container to contain the sheath fluid. Preferably, the sheath pump 122 is a positive displacement pump. More preferably, the sheath pump 122 is a peristaltic pump with a flexible tube and one or more cams that pump the sheath fluid through the flexible tube. The sheath pump 122 preferably has a known flow rate to pump speed ratio, such that control of the speed of the sheath pump 122 corresponds to a control of the flow rate of the sheath fluid. The volume of sheath fluid pumped into the system is preferably derived from the known flow rate to speed value and the speed of the motor. The volume of sheath fluid pumped into the system may alternatively be derived by including a volume sensor (e.g., optical sensor, resistive sensor, etc.) in the sheath container and measuring the decline in volume. A flow rate sensor, volume sensor, or any suitable sensor may alternatively be used. The sheath pump 122 preferably cooperates with the waste pump 124 to draw the sample fluid 110 up through the sample injection probe (SIP) 126.

The waste pump 124 of the preferred embodiment functions to pump the waste fluid from the interrogation zone into a waste container. Preferably, the waste fluid includes the sheath fluid and the sample fluid. Alternatively, the waste fluid may include any fluid that exits the interrogation zone. The waste container is preferably a vented tank with a volume of approximately 1 L, but the waste tank may alternatively be any suitable container to contain the waste fluid. Like the sheath pump 122, the waste pump 124 is preferably a positive displacement pump and more preferably a peristaltic pump with a flexible tube and one or more cams that pump the waste fluid through the flexible tube. The waste pump 124 preferably has a known flow rate to pump speed ratio, such that control of the speed of the waste pump corresponds to a control of the flow rate of the waste fluid. The volume of sheath fluid pumped into the system is preferably derived from the known flow rate to speed value and the speed of the motor. The volume of waste fluid pumped from the system may alternatively be derived by including a volume sensor (e.g., optical sensor, resistive sensor, etc.) in the waste container and measuring the increase in waste volume. A flow rate sensor, volume sensor, or any suitable sensor may alternatively be used.

The sample injection probe (SIP) 126 of the preferred embodiment functions to convey the sample fluid from a sample container into the interrogation zone 130. The sheath pump 122 and the waste pump 124 preferably cooperate to create a fluidic pressure differential (e.g., the sheath pump 122 “pushes” the sheath fluid and the waste pump 124 “pulls” the sheath fluid and the sample fluid) that draws the sample fluid no through the SIP 126 into the fluidic system. The SIP 126 is preferably a syringe, drawtube, or any suitable device that functions to convey the sample fluid no from the sample container into the interrogation zone 130. The sample container, which functions to contain the sample fluid no, is preferably an open beaker with a volume of approximately 5 mL, a wellplate, or may alternatively be any suitable container to contain the sample fluid no.

The interrogation zone 130 of the preferred embodiment functions to inspect the particles of the sample fluid no. A light source, preferably a laser light source, is preferably directed at the hydrodynamically focused sample fluid no. Multiple detectors arranged around the interrogation zone preferably detect the scattered or fluorescent light from the particles. Any suitable optical setup or detection method may alternatively be used to count and analyze the particles of the sample fluid no. The interrogation zone preferably monitors multiple types of particles during any single experiment. Reference beads 112 contained in the prepared sample fluid 110 are preferably counted while analyzing other particles of the sample fluid no. The expected volume of sample fluid 110 that has been through the interrogation zone 130 can preferably be calculated by relating the reference bead count and the expected concentration of reference beads (where the reference beads are uniformly distributed in the sample fluid).

The controller 150 of the preferred embodiment functions to adjust the flow rate of the sample fluid from the sample container into the interrogation zone 130. The adjustment of flow rate includes adjusting the flow rate of the sample fluid to a substantially slow or substantially paused flow rate, including temporarily pausing and completely stopping flow rate of the sample fluid from the sample container to the interrogation zone. A substantially paused flow rate is preferably defined as having a flow rate of 10 microliters/second or less, and more preferably of 1 microliter/second or less. Alternatively, a substantially paused flow rate may be defined as a flow rate of 1% or less of a previous operational value (i.e., the flow rate value at which sample fluid is flowing during normal operation prior to pausing the flow) or 0.1% or less of a previous operational value. However, a substantially paused flow rate may alternatively be defined as any suitable volume per unit time or any suitable reduced flow rate relative to a previous flow rate value. Preferably, the controller 150 adjusts the flow rate of the sample fluid by adjusting the variable flow rate of the sheath fluid and/or the waste fluid. More preferably, the controller 150 adjusts the flow rate of the sample fluid by allowing an adjustable flow rate of the sheath fluid from the sheath container to the interrogation zone 130, while maintaining a consistent flow rate of the waste fluid from the interrogation zone into the waste container. One advantage of this arrangement is a finer and more immediate control of the flow rate of the sample fluid. Another advantage is finer control of the diameter of the sample fluid core stream within the sheath fluid. Alternatively, the controller may adjust the flow rate of the waste fluid while maintaining the flow rate of the sheath fluid, or may simultaneously adjust the flow rates of the sheath fluid and the waste fluid. Furthermore, the controller 150 may employ one technique (such as allowing an adjustable flow rate of the sheath fluid, while maintaining a consistent flow rate of the waste fluid) in most situations, and may employ another technique (such as simultaneously adjusting the flow rates of the sheath fluid and the waste fluid) in other situations to quickly respond to a user input. The controller 150 is preferably a proportional-integral-derivative (PID) controller, but may alternatively be a proportional-integral (PI) controller, a proportional (P) controller, or any suitable controller.

The processor 140 of the preferred embodiment functions to monitor the status and results of the flow cytometer system. The processor 140 is preferably any suitable processor or computer system, such as a personal computer or an embedded system. The processor 140 is preferably capable of monitoring (e.g., reading or accessing) results from the sample fluid analysis performed in the interrogation zone 130. In particular, the processor 140 preferably monitors the reference bead count data. The reference bead count data may be the total bead count, a time based function of reference bead count, or any suitable data concerning the reference bead count. From the reference bead count data, an expected sample fluid volume is preferably calculated. The expected reference bead concentration is preferably collected by the processor prior to calculating the expected sample fluid volume. An experimenter or alternatively a sample preparation machine preferably enters the reference bead concentration information into the processor via a human computer interface (such as a keyboard and mouse). The information may alternatively be associated with the reagent(s), the type of test, or any suitable parameter. The expected reference bead concentration may alternatively be calculated by the processor 140 from data on the volume of factory prepared reagents (with reference beads) used, and/or from any suitable sample preparation data or information. The processor 140 is additionally capable of accessing, collecting, and/or forming data from the peristaltic pump system 120. In particular, the processor monitors the volume of sheath fluid pumped by the sheath pump 122 and the amount of waste fluid pumped by the waste pump 124. The volume of fluid pumped by a peristaltic pump (based on data such as motor speed/rotation and known flow rate to speed value of the pump) is preferably a well-defined value. The difference between the sheath fluid volume and the waste fluid volume is preferably the actual sample fluid volume (the sample fluid was introduced into the fluidic system via the SIP 126). Alternatively, the actual sample fluid volume may be determined by any suitable means, such as by volume sensors within the sheath fluid tank and waste fluid tank, the sample container, and/or flow sensors. Determination of the actual sample fluid volume may be coordinated with the controller to obtain more accurate measurements. For example, a sensor system may measure the amount of the sample fluid in the sample container when the controller adjusts sample fluid flow from the sample container to a substantially slow flow rate (such as a pause in the sample flow rate) such that a measurement of a substantially stable sample volume may be obtained. Alternatively, determination of the actual sample fluid may be performed when the sample fluid flow rate is slow enough to reduce the volume of sample fluid in the sample container by an amount less than the error margin of the sensor system, or under any suitable conditions. The processor preferably compares the expected sample fluid volume and the actual sample fluid volume of a sample solution. If the volumes are not the same, the processor 140 preferably flags the data (e.g., displaying a warning to the experimenter), recommends or performs an experimental change (e.g., adjusting the preparation of the sample fluid or subsequent sample fluids), accounts for the discrepancy in volumes (e.g., adjusting data results based on actual reagent concentration), and/or performs any suitable course of action based on the volume difference.

In one example, the flow cytometer system 100 may be used for a CD₄ test. A CD₄ test is preferably used in the assessment of the immune system and the progress of an HW infection into AIDS. The CD₄ test may involve taking 50 μL of blood and adding 450 μL of reagent(s). In one version, the reagent(s) is preferably a factory prepared solution that contains a known concentration of reference beads. The factory mixed reagent(s) functions to set the reagent(s) to reference bead concentration ratio. In another version, a sample container for a set volume may be provided with the reference beads packaged or pre-added. In yet another version, the reference beads may be added in a controlled manner, by the experimenter and/or by any suitable means. The sample fluid is preferably run through the flow cytometer for analysis. The CD₄ (and CD8) cells are preferably counted along with the number of reference beads by the flow cytometer. In the case where the expected sample fluid volume matches the actual sample fluid volume, the concentration of the CD₄ (and CD8) cells in the blood is calculated. In the case where the expected sample fluid volume does not match the actual sample fluid volume, the experimenter is preferably alerted to this error and/or any suitable action is taken based on the error.

### 2. Method of Verifying the Preparation of a Sample

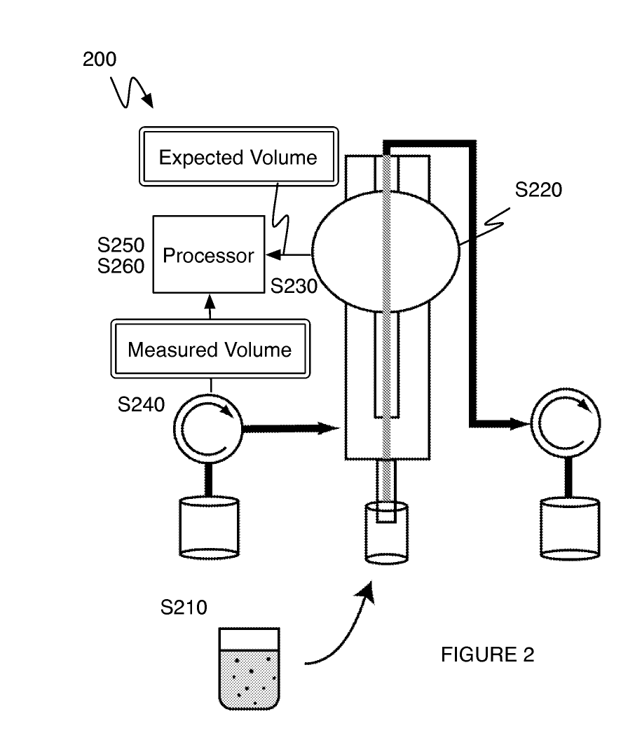

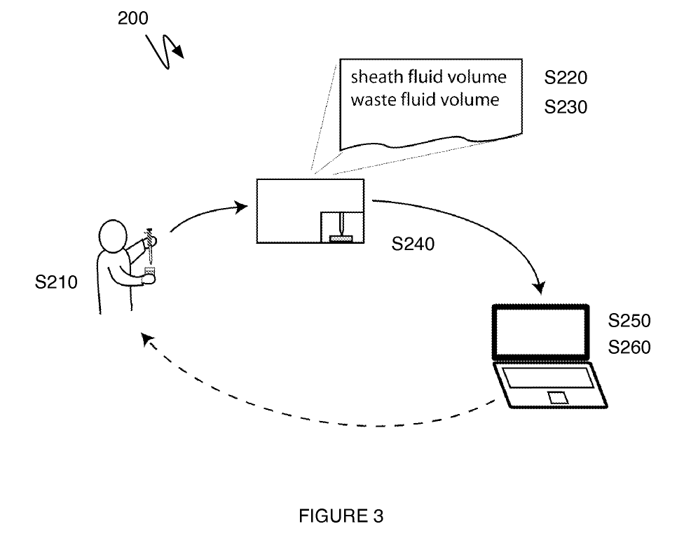

As shown in FIGS. 2 and 3, a method 200 of verifying the preparation of a sample for a flow cytometer includes preparing a sample fluid with reference beads S210, analyzing a sample fluid S220, determining an expected sample volume from particle analysis S230, measuring a sample fluid volume introduced into a fluidic system S240, comparing the measured sample volume to the expected sample volume S250, and performing an error correction action S260. The method functions to verify the measured sample fluid to meets expected fluid preparation parameters. The method preferably takes advantage of a correlation between the operation of the fluidic system and the volume of sample fluid drawn into the interrogation zone.

Step S210, which includes preparing a sample fluid with reference beads, functions to prepare a sample fluid with an expected reference bead concentration. The sample preferably includes blood, but may be any suitable substance or liquid. The reference beads are preferably included in a reagent(s) of reagents that the experimenter adds to a sample. The reagent(s) with reference beads is preferably prepared in a factory or in a controlled environment and provided to the experimenter. The reagent(s) is preferably designed for a particular test such as the CD₄ test. The reference beads may alternatively be added separately by the experimenter or added to the sample fluid in any suitable manner. The reference beads may alternatively be any suitable element that can be used to deduce the expected volume of the sample such as a countable particle with a known concentration in the sample. Additionally, a plurality of distinguishable types of reference beads may be added when preparing the sample fluid. Each type of reference bead is preferably at a known concentration for a particular reagent. A plurality of reagents each with known concentration of reference beads is then preferably mixed or used to prepare a sample fluid. The plurality of reference beads for a plurality of reagents preferably will generate an expected reference bead ratio in the sample fluid.

Step S220, which includes analyzing a sample fluid, functions to perform a flow cytometer analysis of the sample fluid. The sample fluid is preferably hydrodynamically focused through the interrogation zone of the flow cytometer. Particles of interest are preferably analyzed or counted (such as CD₄ cells) and the reference beads are additionally counted. Analyzing the sample fluid preferably includes, hydrodynamically focusing the sample fluid and directing a light source at the sample. The light source is preferably a laser light source but any suitable light source may alternatively be used. Multiple detectors arranged around the interrogation zone preferably detect scattered or fluorescent light from the particles. Any suitable optical setup or detection method may alternatively be used to count and analyze the particles of the sample fluid. If a plurality of types of reference beads is included in the sample fluid, each type of reference bead is preferably independently counted. The types of reference beads preferably differ in size or fluorescence such that the flow cytometer can distinguish between the reference beads.

Step S230, which includes determining an expected sample volume from particle analysis functions to calculate the volume of the sample fluid that has been analyzed based on the reference bead count. An expected reference bead concentration of the sample fluid is preferably known (based on the preparation of the sample fluid) such that the expected sample fluid volume can be calculated from the reference bead counted during the flow cytometer analysis. The expected reference bead concentration is preferably collected by a computer system. The expected reference bead concentration may alternatively be calculated from data on the volume of a factory prepared reagents (with reference beads) used, and/or from any suitable preparation data or information. An experimenter or alternatively a sample preparation machine provides the computer system with the reference bead concentration information. In the variation where a plurality of reference beads is prepared in the sample fluid, an expected reference bead ratio is preferably additionally determined. The ratio is preferably dependent on the preparation of the sample fluid. A reference bead ratio is preferably measured by the flow cytometer such that the expected reference bead ratio can preferably be compared to the measured reference bead ratio.

Step S240, which includes measuring a sample fluid volume introduced into a fluidic system, functions to calculate the actual sample fluid that has passed through the interrogation zone. The fluidic system is preferably a peristaltic pump system with a sheath peristaltic pump and a waste peristaltic pump. The fluidic system is more preferably substantially similar to the peristaltic pump system described above. The volume of sheath fluid pumped into the system is preferably calculated from the known flow rate to speed value and the speed of the motor or alternatively, the volume of sheath fluid may be calculated from any suitable characteristics of the peristaltic pump such as motor rotation. The volume of waste fluid is preferably calculated in a substantially similar way. The difference between the volume of waste fluid and the volume of sheath fluid is equal to the volume of sample fluid (V_{waste}−Vₛₕₑₐₜₕ=Vₛₐₘₚₗₑ) introduced through a SIP (as described above). As a variation, the volume pumped by the sheath pump or the waste pump may be a set amount, while the other pump is dynamically changed to control the rate. In this variation, the volume pumped by the dynamically altered pump may be measured. The volume of the sample fluid may alternatively be obtained by monitoring the volume of a sheath fluid container and the volume of a waste fluid container, the volume of sample fluid in the sample container, fluid flow sensors, and/or any suitable volume measuring techniques.

Step S250, which includes comparing the measured sample volume to the expected sample volume, functions to verify the sample fluid is prepared according to the expectations of the experimenter. The expected sample fluid volume ideally will be substantially equal to the actual sample fluid volume for a properly prepared sample fluid. However, the reference bead count will preferably indicate a different volume than was actually passed through the flow cytometer in a case where the sample is improperly prepared. In the variation where a plurality of reference beads is prepared in the sample fluid, the ratio of the types of reference beads is preferably calculated. There may additionally be a threshold for the difference between the expected sample fluid volume and the actual sample fluid volume, which would function to allow for a level of variation in the volumes.

Step S260, which includes performing an error correction action, functions to resolve any errors with the preparation of the sample fluid. The error correction action preferably occurs when the expected sample fluid volume does not match the actual sample fluid volume (i.e., a preparation error). The error correction action preferably includes alerting the experimenter (or any other suitable person) to the occurrence of the preparation error. An allowable preparation error may additionally and/or alternatively be used as a threshold to determine when the experimenter should be notified. The notification preferably occurs on a graphical display, but may alternatively be indicated in the data results, a sound alert, and/or in any suitable manner. The experimenter when informed of the error preferably prepares a new sample, corrects remaining samples, reruns the experiment, and/or performs any suitable action. The error correction action may additionally or alternatively include recommending or performing an experimental change (e.g., adjustment to the preparation of the sample fluid or subsequent sample fluids), accounting for the discrepancy in volumes (e.g., adjusting data results based on actual reagent concentration), refining the expected reference bead concentration, and/or performing any suitable course of action based on the volume difference. Alternatively, an action may be performed when the expected sample fluid volume prediction is sufficiently equal to the measured sample fluid volume. Any suitable action may be performed based on the equality or inequality of the expected sample fluid volume and the measured sample fluid volume.

### 3. System and Method of the Alternative Embodiments

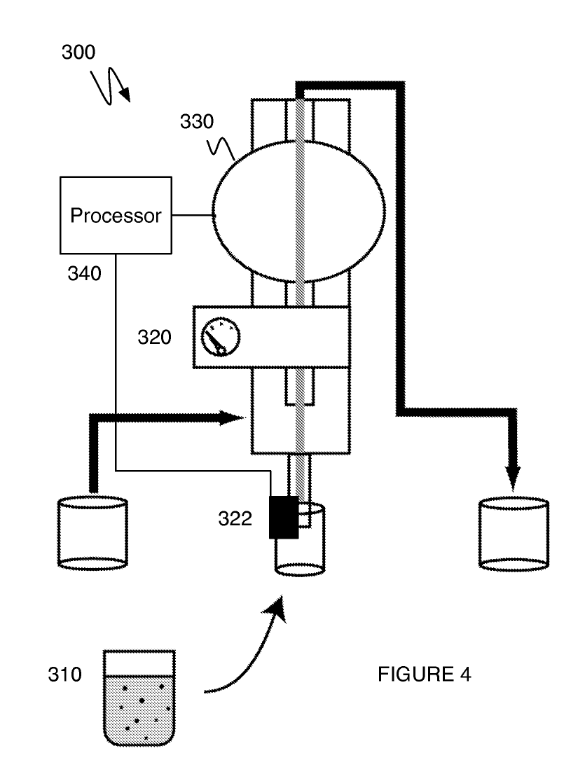

As shown in FIG. 4, the flow cytometer system 300 of the alternative embodiments for the verification of a prepared sample includes a sample fluid prepared with beads 310, a volume sensing fluidic system 320, an interrogation zone 330, and a processor 340. The flow cytometer system 300 functions to compare the actual sample volume as determined by the volume sensing fluidic system to the expected volume of the prepared sample (as indicated by the reference beads in the sample). Discrepancies in these two volume measurements are preferably handled by flagging data, alerting the experimenter, correcting for volume discrepancies, modification of a sample, and/or any suitable response. Except for the substitution of the volume sensing fluidic system for the peristaltic pump system, the flow cytometer system of the alternative embodiment is substantially similar to the flow cytometer system of the preferred embodiment.

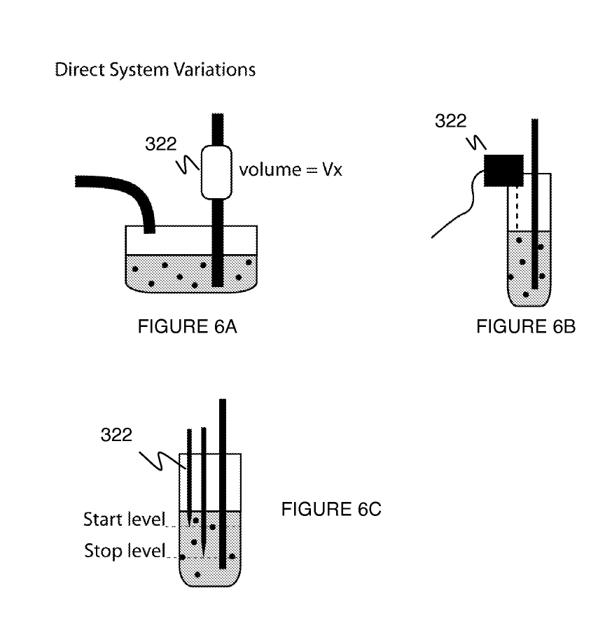

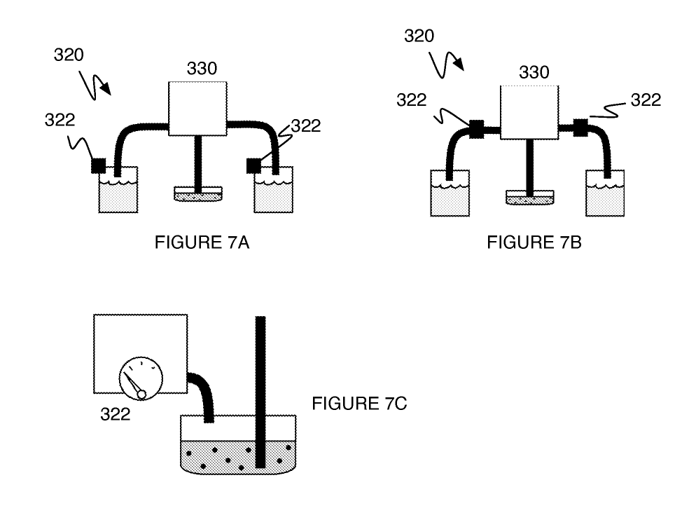

The volume sensing fluidic system 320 of the alternative embodiments functions to measure the volume of sample fluid analyzed by the flow cytometer. The fluidic system of a flow cytometer preferably functions to hydrodynamically focus a sample fluid into an interrogation zone. A sheath fluid is preferably used to hydrodynamically focus the sample fluid, and a sheath and sample fluid mixture is preferably deposited as a waste fluid into a waste container. However, any suitable fluidic system may alternatively be used. The volume sensing fluidic system preferably uses the operation data of components of a flow cytometer such as motor speed, motor rotation, pump pressure, fluidic pressure, sample cycles, and/or any suitable fluidic system operational data. Alternatively, the volume sensing fluidic system may include additional sensors to a fluidic system, an add-on device for a fluidic system, and/or be any suitable device. As shown in FIGS. 6A-6C, the volume sensing fluid system of a first variation measures the sample fluid volume with a direct system (i.e., a system that measures the sample fluid). As shown in FIGS. 7A-7C, the volume sensing fluid system of a second variation, however, measure the sample fluid volume with an indirect system (i.e., a system that measures other fluid volumes to deduce the actual sample fluid volume). The indirect system may be similar to the variations described above except applied to sheath fluid and/or waste fluid. The volume sensing fluid system may alternatively measure the sample fluid volume in any suitable manner.

As shown in FIGS. 6A-6C, the direct system preferably functions to actively measure the sample fluid volume. In one version, a direct system is used in a fluidic system that incorporates an air and/or vacuum pump to pressurize and pump sheath fluid from a high-pressure container to the interrogation zone of a flow cell. A syringe, container, or reservoir is preferably filled with the sample before introduction to the interrogation zone. The syringe functions to allow for dispensing precise volumes of fluid. The syringe preferably has a known volume, and the syringe is preferably filled to this known volume for each introduction of the fluid into the fluidic system. The volume of the actual sample fluid volume analyzed is thus a multiple of the syringe volume, and is dependent on the number of times a full syringe volume was introduced into the system. In another version, a sample fluid container with well-defined volume levels (e.g., a test tube with a large height to diameter ratio) is used in cooperation with a container volume sensor 322. Two or more fluid level sensors may alternatively be used to sense the volume of a sample between one or more levels as shown in FIG. 6C. The sample fluid is preferably run through the flow cytometer until the sample fluid container reaches a start level of fluid at a first level sensor (the start level sensor). The sample fluid is then run through the system with the flow cytometer preferably performing the analysis. A second level sensor (the stop level sensor) is preferably located at a lower level than the start level sensor. The stop level sensor preferably indicates when the sample fluid in the container has reached the stop level. The volume of sample fluid between the start and stop level sensor is preferably known value. The sample container may alternatively have a calibrated volume profile. A volume profile preferably includes any suitable data such that the level or level change of a fluid within the sample container can be used to calculate the volume of fluid remaining in the sample container or removed from the sample container. The container volume sensor 322 functions to measure the volume of sample withdrawn from the fluid container as shown in FIG. 6B. The container volume sensor 322 may be a distance sensor perpendicularly inspecting the surface of the sample fluid in the sample container, a resistive or capacitive sensor inspecting the fluid level in the sample container, an image system inspecting the surface and/or side profile of the sample container, and/or any suitable sensor to measure the volume of the sample fluid in the fluid container. The direct system may alternatively include any device that directly measures the sample fluid withdrawn from a container or passing through the fluidic system. The direct system may include an intake sensor along the main channel through which the sample fluid is introduced to the fluidic system, as shown in FIG. 6A. The intake sensor is preferably coupled to the SIP or drawtube before the interrogation zone 330. The intake sensor preferably measures the volume, flow rate, or any suitable parameter to deduce the volume of sample fluid introduced to the system. In yet another version, the direct system includes a sensor such as a scale or a balance that measures the weight or mass of the analyzed sample fluid, from which the measured volume may be calculated based on a known or given density of the sample fluid. The sensor system in the direct system may include any combination of the various versions. Furthermore, the measurements of the combination may be averaged or combined any suitable manner to obtain a measured volume of sample analyzed in the interrogation zone.

As shown in FIGS. 7A-7C, the indirect system preferably calculates a sample fluid volume by calculating the volume of other fluids through the fluidic system. Preferably the sheath fluid volume and/or the waste fluid volume are measured. The waste fluid is preferably the sum of a sample fluid and sheath fluid. The sample volume is preferably calculated by subtracting the measured sheath fluid volume and the waste fluid volume. The volume of a collection fluid (fluid separated from the waste fluid) may additionally be measured, and the sheath fluid is subtracted from the sum of the waste fluid and collection fluid. Any number of volumes may alternatively be measured and the sample fluid volume may be calculated by subtracting appropriate volumes from a sum total volume. In one version, the volumes of a sheath container and a waste container may include sensors to measure the volume introduced and removed from the system. A fluid with a known fluidic flow relationship with the sample fluid may alternatively be used. In another version, the sample fluid volume may be calculated using a sheath to sample fluid ratio based on pumping pressure. The indirect system may alternatively use the variations described above, but applied to the sheath fluid, waste fluid, collection fluid, and/or any suitable fluids.

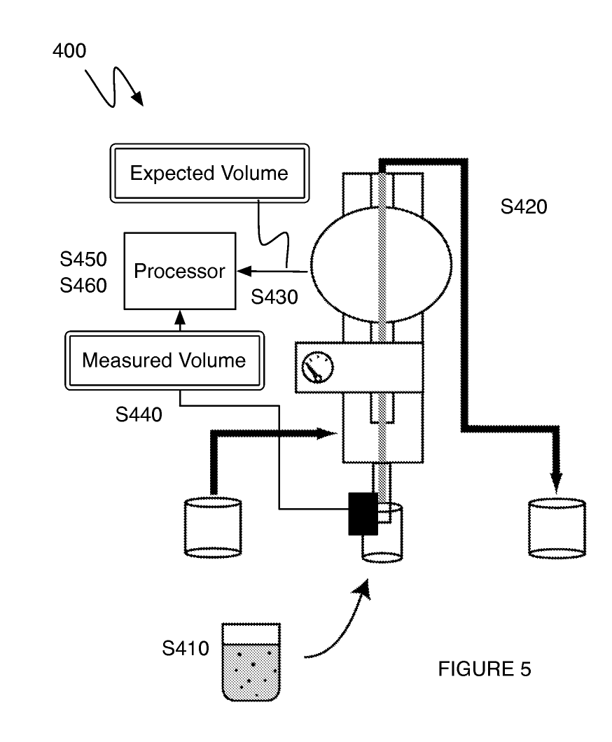

As shown in FIG. 5, the method 400 of verifying the preparation of a sample for a flow cytometer of the alternative embodiments includes preparing a sample fluid with reference beads S410, analyzing a sample fluid S420, determining an expected sample volume from particle analysis S430, measuring a sample fluid volume introduced into a fluidic system S440, comparing the measured sample volume to the expected sample volume S450, and performing an error correction action S460. The method functions to verify the measured sample fluid to the desired preparation. Except for the substitution of a new Step S440, the method of the alternative embodiment is substantially similar to the method 200 of the preferred embodiment.

Step S440 of the alternative embodiments, which includes measuring a sample fluid volume introduced into a fluidic system, functions to calculate the actual sample fluid that has passed through the interrogation zone. The fluidic system is preferably any fluidic system commonly used in a flow cytometer such as a flow cytometer that incorporates an air and/or vacuum pump to pressurize and pump sheath fluid from a high-pressure container to the interrogation zone of a flow cell. The fluidic system of a flow cytometer preferably functions to hydrodynamically focus a sample fluid in an interrogation zone. A sheath fluid is preferably used, and the sheath and sample fluid mixture is preferably deposited as a waste fluid. However, any suitable fluidic system may alternatively be used. The volume sensing fluidic system preferably uses the operation data of components of a flow cytometer such as motor speed, motor rotation, pump pressure, fluidic pressure, sample cycles, electrical sensor data, and/or any suitable fluidic system operational data. Alternatively, the volume sensing fluidic system may include additional sensors to a fluidic system, an add-on device for a fluidic system, and/or be any suitable device. The volume sensing fluid system preferably measures the sample fluid volume with a direct system. The direct system preferably measures the sample fluid directly. The direct system is preferably substantially similar to the one described above. In one variation of a direct system, discrete and precise volumes of the sample fluid may be introduced to the system, and the actual sample volume will always be a known multiple of the precise volume. In another variation of a direct system, a sensor may measure the volume of sample fluid withdrawn from a container (such as a beaker). Any suitable variation of a direct system may be used such as sensing fluid flow, fluid velocity, and/or any suitable method of sensing the sample fluid volume introduced into the fluidic system. The volume sensing fluid system may alternatively measure the sample fluid volume with an indirect system. The indirect system preferably measures or calculates multiple fluid volumes to deduce the sample fluid volume. More preferably, the indirect method subtracts the sheath fluid from the waste fluid. Though any suitable fluids introduced into the system may be used including other liquids and/or gases. In one variation, electric sensors are used to monitor the volumes of a sheath container (where sheath fluid is stored before being introduced into the system) and the volumes of a waste container (where waste fluid is deposited after analysis). The sheath fluid volume (fluid introduced into the system) is then subtracted from the waste fluid to calculate the actual sample fluid volume. In another variation a fluid process is monitored that can be used to calculate the actual sample fluid volume. The other fluid process (such as pump pressure) preferably relates to the precise amount of sample fluid introduced into the flow cytometer.

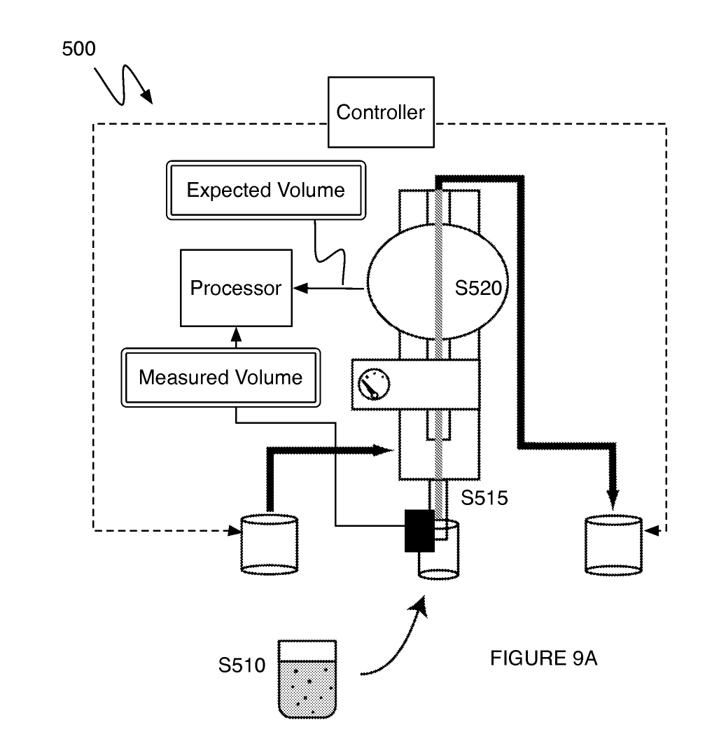

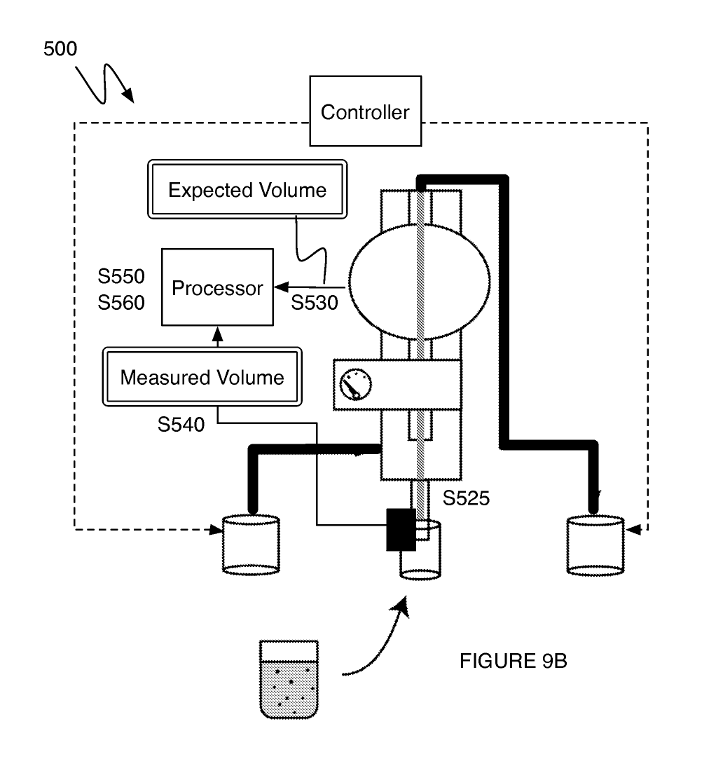

As shown in FIGS. 9A and 9B, in another alternative embodiment the method 500 of verifying an amount of sample fluid and pumping sample fluid from a sample container includes drawing sample fluid flow from the sample container into the interrogation zone S505, analyzing the sample fluid in the interrogation zone S520, substantially pausing the flow of the sample fluid from the sample container into the interrogation zone S525, and measuring the amount of sample fluid in the sample container while the sample fluid flow is substantially slowed S540. In some embodiments, the method further includes preparing a sample fluid with reference beads S510, determining an expected sample volume from particle analysis S530, comparing the measured sample volume to the expected sample volume S550, and performing an error correction action S560. The method 500 may include the step of agitating the sample fluid (e.g., agitating the sample container with a stirrer or shaker), which reduces settling or sedimentation of the sample fluid (for example, during step S525 of pausing the flow of sample fluid or immediately before resuming flow of sample fluid, or at any suitable time). The method functions to verify the amount of sample fluid introduced into a fluidic system. In one application, the method may be used to calibrate a reference bead counter in the flow cytometer or other suitable instrument for determining sample volume. Except as described below, the method of this alternative embodiment is preferably substantially similar to the method 400.

Step S505, which includes drawing sample fluid flow from the sample container into the interrogation zone, functions to introduce sample fluid into the fluidic system for particle analysis. The sheath pump and the waste pump preferably cooperate to draw the sample fluid from the sample container into the interrogation zone through the use of a pressure differential. In order to allow a variable flow rate of the sample fluid, the fluidic system preferably allows for a variable flow rate of the sheath fluid and/or the waste fluid. Variations of the step of drawing sample fluid flow from the sample container into the interrogation zone are described in U.S. Pub. No. 2007/0212262. Step S505 may, however, include other suitable variations that draw the sample fluid from the sample container into the interrogation zone through the use of a pressure differential.

Step S525, which includes substantially pausing the flow of the sample fluid from the sample container into the interrogation zone, functions to substantially stabilize the sample fluid volume in the sample container, to enable obtaining a stable volume measurement. Step S525 preferably includes reducing the sample flow rate from the sample container into the interrogation zone to 10 microliters/second or less, and more preferably includes reducing the sample flow from the sample container into the interrogation zone to 1 microliter/second or less. Alternatively, Step S525 may include reducing the sample flow rate from the sample container into the interrogation zone to 1% or less of a previous operational value (i.e., the flow rate value at which the sample fluid is flowing during normal operation prior to pausing the flow) or 0.1% or less of a previous operational value. However, Steps S525 may include any suitable step for substantially pausing or reducing the flow rate of the sample fluid from the sample container into the interrogation zone. In one variation of step S525, the controller pauses the flow of both the sheath fluid and waste fluid (i.e., sheath and waste fluid flow rates are adjusted to zero) to pause the flow rate of the sample fluid. In another variation, the controller substantially slows the flow of the sheath fluid while pausing the flow of the waste fluid to substantially slow the flow rate of the sample fluid. In yet another variation, the controller pauses the flow rate of the sheath fluid while substantially slowing the flow of the waste fluid to substantially slow the flow rate of the sample fluid. However, step S525 may additionally and/or alternatively include activating a valve to block flow of sample fluid from the sample container into the interrogation zone, or any suitable step for substantially slowing the flow rate of sample fluid. Step S525 preferably slows the flow rate of the sample fluid to allow the sample volume level in the sample container to change by an amount within an error margin of the sensor system that measures actual sample volume.

S540, which includes measuring the amount of sample fluid in the sample container while the sample fluid flow is substantially slowed, functions to obtain a stable measurement. Step S540 is preferably similar to step S440 of method 400, except that the volume sensor system is preferably coordinated with the controller such that measurement is performed while the sample flow from the sample container to the interrogation zone is substantially slowed or paused.

As a person skilled in the art will recognize from the previous detailed description and from the figures and claims, modifications and changes can be made to the preferred and alternative embodiments of the invention without departing from the scope of this invention defined in the following claims.

We claim:

1. A flow cytometer system for verifying an amount of sample fluid and pumping sample fluid from a sample container into an interrogation zone of a flow cytometer that analyzes the sample fluid, comprising:
a sheath pump that pumps sheath fluid from a sheath container into the interrogation zone of the flow cytometer,
a waste pump that pumps waste fluid from the interrogation zone into a waste container;
wherein the sheath pump and the waste pump cooperatively and simultaneously draw sample fluid from the sample container into the interrogation zone;
a controller that adjusts the flow rate of the sample fluid from the sample container into the interrogation zone by controlling at least one of the flow rates of the sheath fluid and the waste fluid; and
a sensor system that coordinates with the controller to measure the amount of sample fluid in the sample container when the controller substantially pauses sample fluid flow from the sample container into the interrogation zone.

2. The flow cytometer system of claim 1, wherein the controller substantially pauses the sample fluid flow from the sample container into the interrogation zone by reducing the sample fluid flow rate from the sample container into the interrogation to 10 microliters/second or less.

3. The flow cytometer system of claim 2, wherein the controller substantially pauses the sample fluid flow from the sample container into the interrogation zone by reducing the sample fluid flow rate from the sample container into the interrogation zone to 1 microliter/second or less.

4. The flow cytometer system of claim 1, wherein the controller repeatedly substantially pauses the flow rate of the sample fluid from the sample container into the interrogation zone and wherein the sensor coordinates with the controller to measure the amount of sample fluid in the sample container when the controller substantially pauses the flow rate of the sample fluid.

5. The flow cytometer system of claim 4, wherein the controller substantially pauses the flow rate of the sample fluid from the sample container into the interrogation zone by temporarily stopping the flow rates of the sheath fluid and the waste fluid.

6. The flow cytometer of claim 5, wherein the sensor measures the change in amount of the sample fluid in the sample container between successive pauses in sample fluid flow.

7. The flow cytometer system of claim 6, wherein the sensor system includes a volume sensor coupled to the sample container that measures the change in volume of the sample fluid in the sample container between successive pauses in sample fluid flow.

8. The flow cytometer system of claim 7, wherein the sensor system includes a first level sensor and a second level sensor located at a lower level than the first level sensor.

9. The flow cytometer system of claim 4, further comprising a processor that determines a measured volume of sample fluid analyzed in the interrogation zone and determines an expected sample volume of sample fluid based on data generated by the analysis of the sample fluid in the interrogation zone, and wherein the processor compares the measured volume of analyzed sample fluid to the expected sample volume.

10. The flow cytometer system of claim 9, wherein the processor determines the measured volume of sample fluid analyzed in the interrogation zone by calculating a change in measured volume of the sample fluid in the sample container between successive pauses in sample fluid flow.

11. The flow cytometer system of claim 10, wherein the sample fluid is a prepared sample that includes an expected reference bead concentration, and wherein the interrogation zone detects the number of reference beads identified in the sample fluid, wherein the processor calculates the expected sample volume based on the expected reference bead concentration and the number of detected reference beads.

12. The flow cytometer system of claim 11, wherein the processor performs an error correction action.

13. The flow cytometer system of claim 12, wherein the error correction action includes refining the expected reference bead concentration based on the comparison between the measured volume of analyzed sample fluid and the expected sample volume.

14. The flow cytometer system of claim 1, wherein the sheath pump pushes sheath fluid from the sheath container into the interrogation zone and the waste pump pulls the waste fluid from the interrogation zone into the waste container to create a fluidic pressure differential.

15. The flow cytometer system of claim 14, wherein at least one of the sheath pump and the waste pump is a peristaltic pump.

16. A method for verifying an amount of sample fluid and pumping sample fluid from a sample container into an interrogation zone of a flow cytometer that analyzes the sample fluid, comprising the steps of:
simultaneously pumping sheath fluid from a sheath container into the interrogation zone and pumping waste fluid from the interrogation zone into a waste container, wherein the flow rate of the sheath fluid is different from the flow rate of the waste fluid thereby drawing sample fluid flow from the sample container into the interrogation zone;
analyzing the sample fluid in the interrogation zone;
substantially pausing the flow of the sample fluid from the sample container into the interrogation zone by temporarily stopping the flow rates of the sheath pump and the waste pump; and
measuring the amount of sample fluid in the sample container while the sample fluid flow is substantially paused.

17. The method of claim 16, wherein the step of substantially pausing the flow of the sample fluid includes reducing the sample flow rate from the sample container into the interrogation zone to 0.5 milliliters/second or less.

18. The method of claim 17, wherein the step of substantially pausing the flow of the sample fluid includes reducing the sample flow rate from the sample container into the interrogation zone to 0.1 milliliters/second or less.

19. The method of claim 16, wherein the step of substantially pausing the flow of the sample fluid is repeated and measuring the amount of sample fluid in the sample container is performed after each time the flow of the sample fluid is paused.

20. The method of claim 19, further comprising determining a measured volume of sample fluid analyzed in the interrogation zone based on a change in measured volume of the sample fluid in the sample container between successive pauses in sample fluid flow.

21. The method of claim 20, wherein determining a measured volume of sample fluid includes directly measuring a start volume level and a stop volume level of sample fluid in the sample container.

22. The method of claim 20, further including preparing the sample fluid and determining an expected sample volume based on analysis of the sample fluid in the interrogation zone.

23. The method of claim 22, wherein preparing the sample fluid includes preparing the sample fluid with an expected reference bead concentration and determining an expected sample volume includes detecting the number of reference beads in the analyzed sample fluid and calculating the expected sample volume based on the expected reference bead concentration and the number of detected reference beads.

24. The method of claim 23, further including performing an error correction action based on the comparison between the measured volume of analyzed sample fluid and the expected sample volume.

25. The method of claim 24, wherein performing an error correction action includes refining the expected reference bead concentration.
